(19) United States
(12) Patent Application Publication
(10) Pub. No.: US 2002/0049657 A1
(43) Pub. Date: Apr. 25, 2002

(54) Web site for retail marketing program

(76) Inventors: Peter T. Main, Bellevue, WA (US); Al A. Demaranville, Seattle, WA (US); Scott L. Volz, Maple Valley, WA (US); Todd J. Bruce, Woodinville, WA (US)

Correspondence Address: NIXON & VANDERHYE P.C., 8th Floor, 1100 North Glebe Road, Arlington, VA, 22201, US

(21) Appl. No.: 09/972,191

(22) Filed: Oct. 9, 2001

Related U.S. Application Data
(60) Provisional application No. 60/252,900, filed on Nov. 27, 2000.
(60) Provisional application No. 60/239,093, filed on Oct. 11, 2000.

(51) Int. Cl. G06F 17/60

(52) U.S. Cl. 705/35

(57) ABSTRACT

A method of marketing comprises determining a cost of at least one item ordered by a user, calculating an amount of credit for use by the user to defray costs of its marketing activities, the amount of credit being based on a cost of the ordered item, providing data relating to the amount of credit to a computer system, and generating a web page using the data provided to the computer system. The web page displays the amount of credit available to the user for its marketing activities. Bonus credit may be earned by the user to defray costs of its marketing activities by advertising a certain item(s) during a predetermined time period or advertising an item for at least a predetermined price.

### CROSS-REFERENCE TO RELATED APPLICATIONS

This application claims the benefit of U.S. Provisional Application No. 60/252,900 filed Nov. 27, 2000 and entitled “Web Site for Retail Marketing Program” and No. 60/239,093 filed Oct. 11, 2000 and entitled “Alliance Web Site.” The contents of both of the above provisional applications are incorporated herein by reference.

### BACKGROUND OF THE INVENTION

1. Field of the Invention

The present invention relates to a secure web site run by a vendor that enables users to search for and view information and data specifically related to their accounts. In particular, the present invention relates to a secure web site run by a vendor that enables retailers to search for and view retail marketing program data related to their accounts.

2. Description of Related Art

Retailers such as department stores have long ordered products from vendors for sale to its customers. After a retailer has ordered products from a vendor, it is typically in the best interests of both the retailer and the vendor that the products be successfully sold to the retailer's customers. In order to promote such sales, the retailers will often engage in marketing activities such as advertising (e.g., television, radio and printed advertisements), promotions (e.g., sweepstakes, contests, gift with purchase events and in-store events) and merchandising (e.g., displays, in-store signs, posters and banners). Costs associated with these marketing activities are often paid for by the retailer and thus provide a disincentive for the retailer to engage in these marketing activities.

At least one vendor has established an incentive program to encourage retailers to market the products ordered from it. As described in its “99 Source Book”, Nintendo® has established a “Retail Marketing Program” in which retailers that have ordered products from Nintendo® can accrue monetary credit to defray the retailer's costs in marketing Nintendo® products. The monetary credit is earned based on a percentage of the total year-to-date dollars that a retailer has accrued on net shipments (gross shipment minus adjustments for product returns, markdowns, etc.) during a given fiscal year. That is, a percentage based on the cost of each type of product purchased by a retailer from Nintendo® is credited to a fund for the retailer to spend on marketing Nintendo® products. For example, a retailer may earn monetary credit worth 3% of the net shipment of all Nintendo® GameBoy® products and 2% of the net shipment of all Nintendo® N64 products. The earned credits are summed together to form the fund which may used by the retailer to pay for costs in marketing Nintendo® products.

As also described in its “99 Source Book”, Nintendo® has established a Minimum Advertised Price (MAP) program as part of the “Retail Marketing Program.” In the MAP program, retailers can accrue additional monetary credit to defray the retailer's costs in marketing Nintendo® products by advertising certain Nintendo® products at a minimum recommended level determined by Nintendo® and satisfying other requirements such as advertising Nintendo® products with a determined frequency, executing an in-store merchandising program and providing a representative sample of certain Nintendo® products during the program.

A statement reflecting, inter alia, the amount of the credit earned (accruals), the amount of the credit approved by Nintendo® to pay for marketing activities (expenditures), and the balance of the fund is provided (e.g., mailed) to each retailer on a periodic (e.g., monthly) basis. The statement will reflect only that particular retailer's account and not an account to any other retailer enrolled in the marketing program unless authorization to the contrary is given. Unfortunately, the statement will only reflect the status of the account as of the date it was provided to the retailer. Changes in the amount of credit earned, credit approved for payment, etc. after that date will not be reflected. Moreover, if the statement is mailed to the retailer, there is delay in the retailer obtaining the statement and a chance that the statement will be lost during the mailing process.

There thus remains a need to eliminate the lengthy information process and facilitate the sharing of information with the retailers enrolled in the marketing program. Specifically, there remains a need for retailers enrolled in the marketing program to be able to have instant access to up-to-date information related to their respective accounts. It would be beneficial to allow the retailer to search for and locate specific information related to their respective accounts in an efficient and easy-to-use manner.

### SUMMARY OF THE INVENTION

In an exemplary embodiment of the present invention, a method of marketing comprises determining a cost of at least one item ordered by a user; calculating an amount of credit for use by the user to defray costs of its marketing activities, the amount of credit being based on a cost of the ordered item; providing data relating to the amount of credit to a computer system; and generating a web page using the data provided to the computer system, the web page displaying the amount of credit available to the user for its marketing activities. The marketing activities may comprise at least one of advertising, merchandising and promotions. An online link on the web page may be established for initiating another web page that displays at least one of the following: a cost of each item ordered by the user, an accrual rate used to determine an amount of credit for each item ordered by the user, an amount of credit already approved for use by the user, and pending request(s) for expenditures from the user. Bonus credit may be earned by the user by performing tasks such as advertising certain item(s) during a predetermined time period and/or advertising a certain item for at least a predetermined price.

In another exemplary embodiment of the invention, a method of implementing a marketing program for item(s) being sold by a user comprises generating an internet web page using a computer system, the web page being accessible by the user; determining a cost of an item ordered by the user; calculating an amount of credit based on the cost of the item ordered by the user, the amount of credit being for use by the user to defray costs associated with marketing the item(s) being sold by the user; and displaying, via the web page, the amount of credit available for use by the user. Marketing the item(s) being sold by the user may comprise at least one of advertising the item(s), merchandising the item(s) and conducting a promotion of the item(s). An online link is established on the web page for initiating another web page that displays at least one of the following: a cost of each item ordered by the user, an accrual rate used to determine an amount of credit for each item ordered by the user, an amount of credit already approved for use by the user, and pending request(s) for expenditures from the user. Bonus credit for use by the user to defray costs of its marketing activities may be earned by performing tasks such as advertising a certain item during a predetermined time period and/or advertising a certain item for at least a predetermined price.

In yet another exemplary embodiment of the invention, a method of marketing comprises determining an amount of credit to be awarded to a user to defray costs of its marketing activities; determining whether the user is entitled to the credit by determining whether the user has advertised, merchandised or promoted a certain item; providing data relating to the amount of credit awarded to the user to a computer system; and generating a web page using the data provided to the computer system, the web page displaying at least the amount of credit available to the user for its marketing activities. The credit may be awarded to the user if the user has advertised a certain item during a predetermined period of time and/or advertised a certain item for at least a predetermined price.

In yet another exemplary embodiment of the present invention, a method of implementing a marketing program for items being sold by a user comprises generating an internet web page using a computer system, the web page being accessible by the user; determining an amount of credit to be awarded to a user to defray costs of its marketing activities; determining whether the user is entitled to the credit by determining whether the user has advertised, merchandised or promoted a certain item; providing data relating to the amount of credit awarded to the user to a computer system; and displaying, via the web page, at least the amount of credit available for use by the user to defray costs of its marketing activities. The credit may be earned if the user has advertised a certain item during a predetermined period of time and/or advertised a certain item for at least a predetermined price.

### BRIEF DESCRIPTION OF THE DRAWINGS

The advantages of the present invention will be more completely understood and appreciated by careful study of the following detailed description of the presently preferred exemplary embodiments of the invention taken in conjunction with the accompanying drawings, in which:

FIG. 1 is a diagram generally illustrating a system in accordance with an exemplary embodiment of the invention;

FIG. 2 illustrates a page of a web site for a retail marketing program in accordance with an exemplary embodiment of the present invention;

FIG. 3 illustrates a page of the web site resulting from the selection of the link “By Product Line” from the web page illustrated in FIG. 2;

FIG. 4 illustrates a page of the web site resulting from the selection of the link “Advertising” from the web page illustrated in FIG. 2;

FIG. 5 illustrates a page of the web site resulting from the selection of the link “Merchandising” from the web page illustrated in FIG. 2;

FIG. 6 illustrates a page of the web site resulting from the selection of the link “Promotions” from the web page illustrated in FIG. 2;

FIG. 7 illustrates a page of the web site resulting from the selection of the link “Pending claims” from the web page illustrated in FIG. 2;

FIG. 8 illustrates a page of the web site resulting from the selection of the link “Club Windows” from the left-hand side navigation bar of the web site;

FIG. 9 illustrates a page of the web site resulting from the selection of the link “Club Calendar” from the left-hand side navigation bar of the web site; and

FIG. 10 illustrates a page of the web site resulting from the selection of the link “Map Schedule” from the left-hand side navigation bar of the web site.

### DETAILED DESCRIPTION OF THE INVENTION

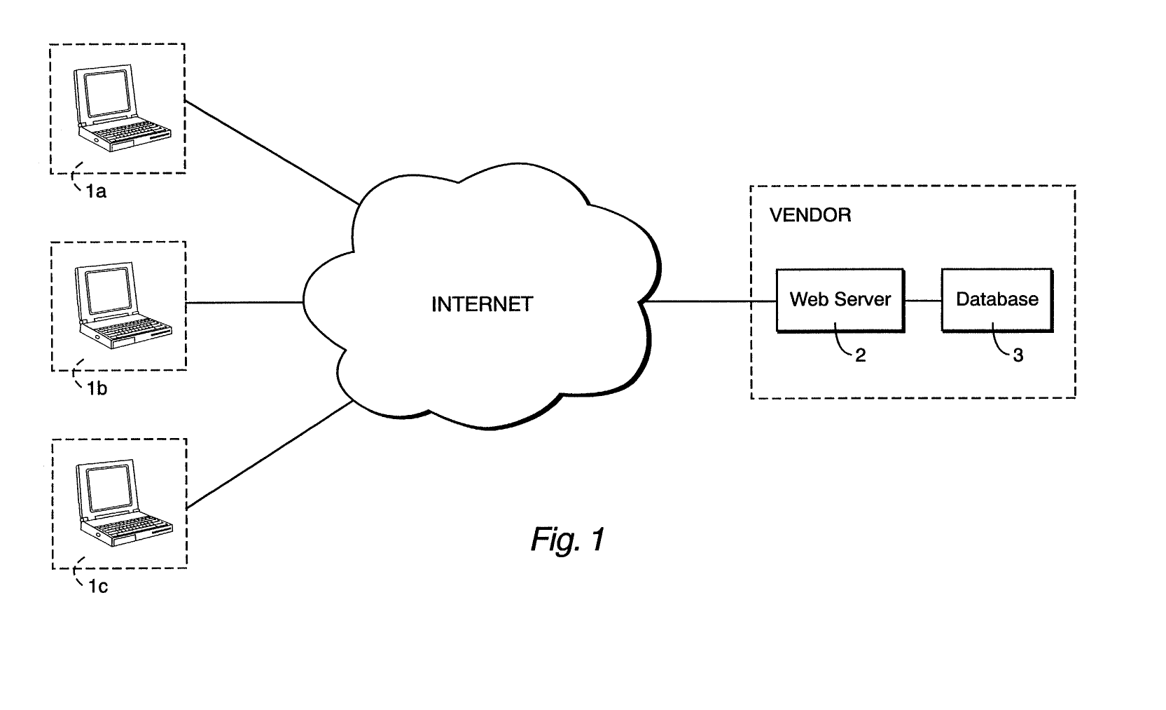

FIG. 1 is a diagram generally illustrating a system for implementing a secure online web site which allows users enrolled in a vendor's marketing program to view information related to their respective accounts with the vendor. The users may be, for example, retailers that order products from the vendor for re-sale to the retailer's customers and that engage in marketing activities such as advertising (e.g., television, radio and printed advertisements), promotions (e.g., sweepstakes, contests, gift with purchase events and in-store events) and merchandising (e.g., displays, in-store signs, posters and banners). The vendor may be, for example, the manufacturer of the products or a retailer that is re-selling the products.

The users that are enrolled in the vendor's marketing program order products for shipment from the vendor. The ordered products may vary in number and type. Pursuant to the policies of the program, each user earns monetary credit (accruals) based on a percentage of the money accrued from the net shipment of a particular product during a specific time period as determined by the vendor. For example, a user may earn a monetary credit worth 3% of the money accrued on the net shipment of a first type of product and a credit worth 2% of the money accrued on the net shipment of a second type of product. All of the credits are summed to form a retail marketing program (RMP) fund which the user may spend, for example, to pay for marketing activities related to the vendor's products. Bonus monetary credit may also be earned by each user if the user performs certain tasks such as advertising a particular one or more of the vendor's products during a specified period of time or advertising a particular one of the vendor's products for at least a minimum price determined by the vendor.

The policies of the vendor's marketing program may be modified so that, for example, the amount of monetary credit is based on the gross shipment of the products rather than the net shipment. The percentage credit on a particular product may also be varied (e.g., raised to a higher level to provide an extra incentive for users to purchase and market a particular product). The policies of the program may also restrict how the credit may be spent by the user such as defining the lowest price that may be listed in an advertisement that is paid for, at least in part, with money from the RMP fund.

Referring to FIG. 1, the system in accordance with an exemplary embodiment of the present invention includes a computer system having a web server 2 which is interfaced at least indirectly with a database 3. The database 3 receives and stores data relating to each of the users' accounts almost continuously and can thus make available to the users enrolled in the program the most up-to-date information possible. The database 3 may receive data that has been processed by other computer system(s) such as a computer system which tracks product shipment from the vendor.

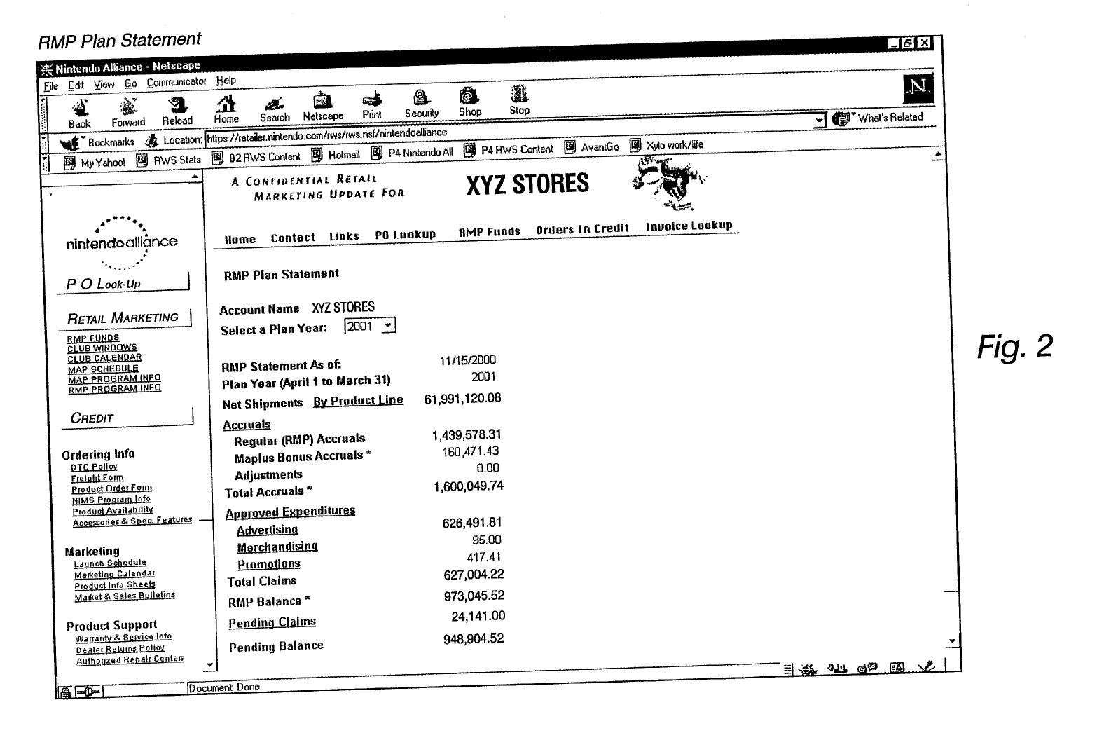

Users 1a-1c may review marketing program data (as will be discussed in more detail below in connection with FIGS. 2-10) related to their respective accounts by accessing the web server 2 operated by the vendor. Each user may access the web server 2 by inputting an appropriate URL and unique log-in password using a web browser operating on the user's terminal. Each user will preferably only be able to access its own account and not those of the other users. Access to the web site can therefore be limited as determined by the vendor.

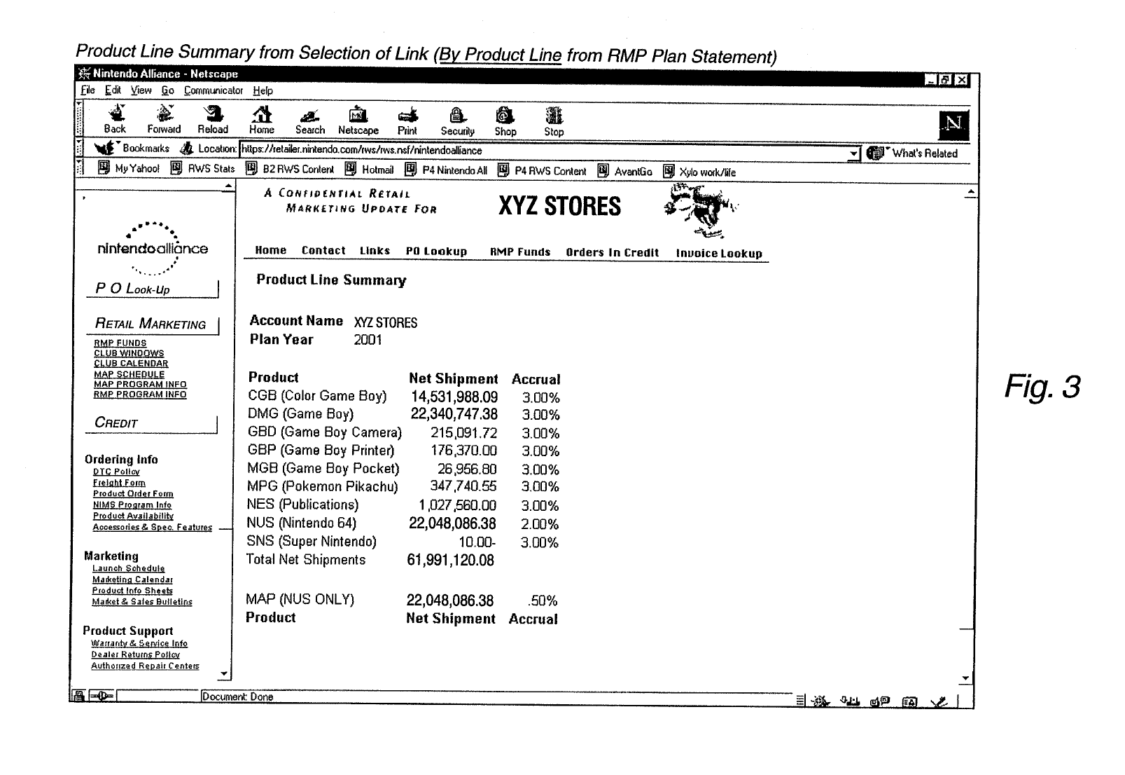

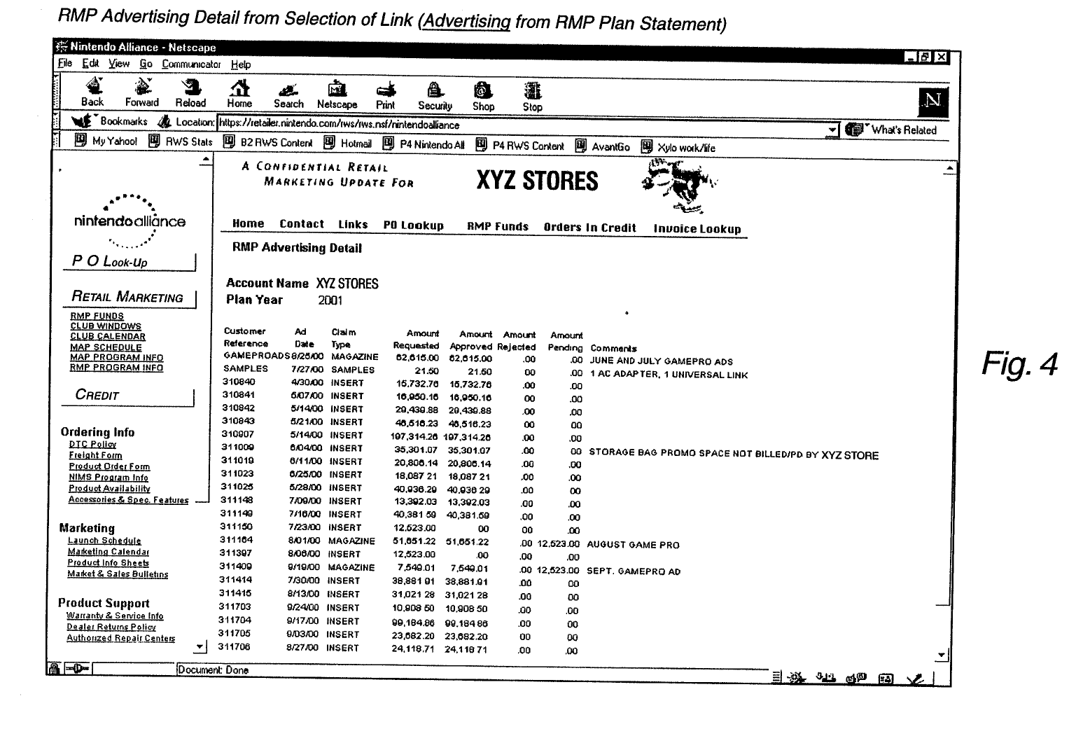

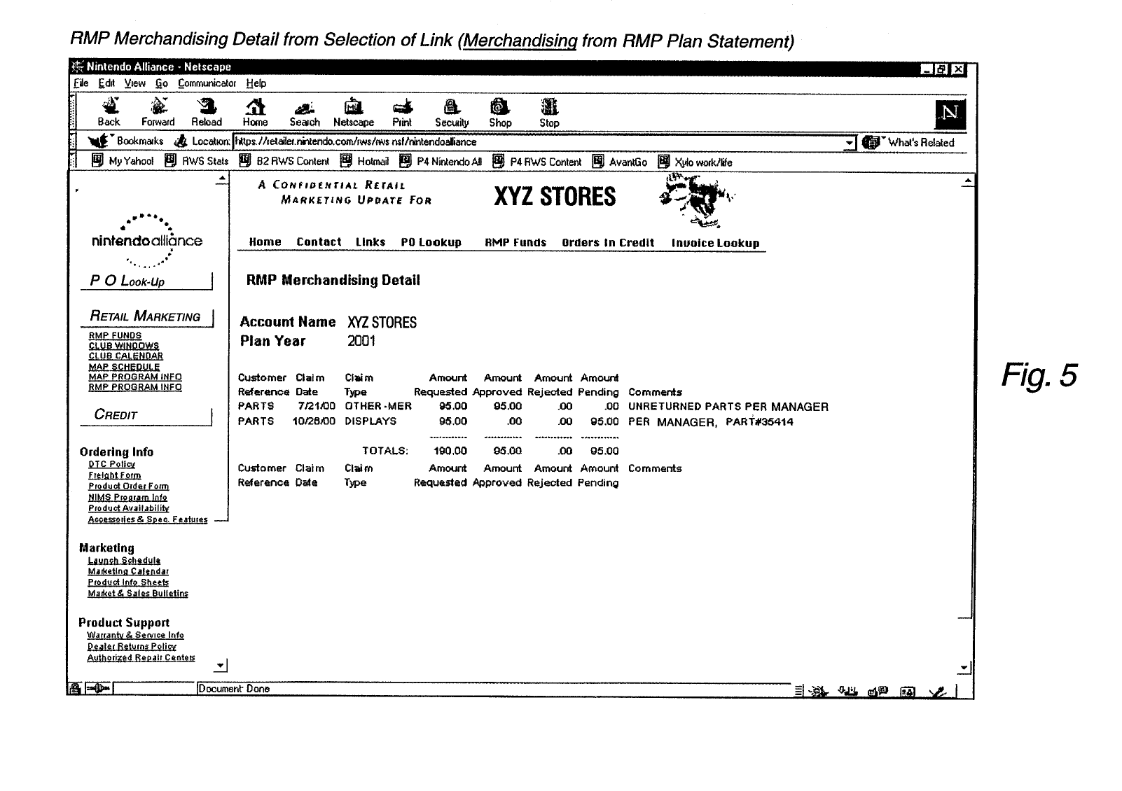

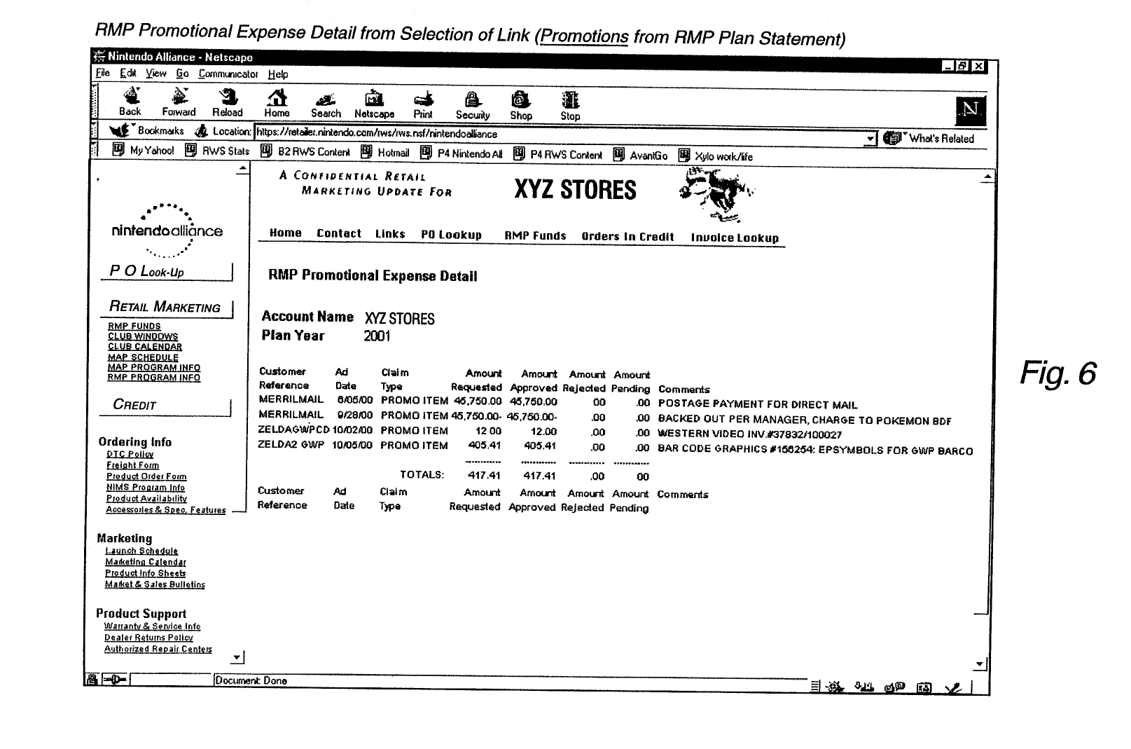

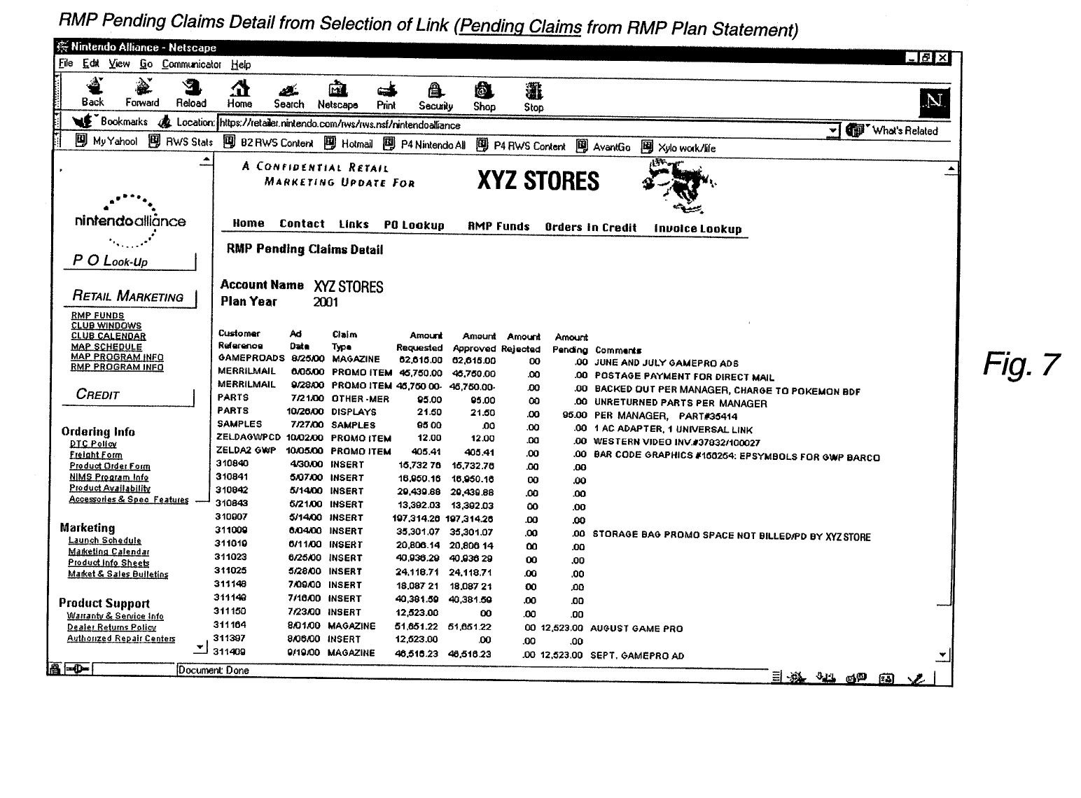

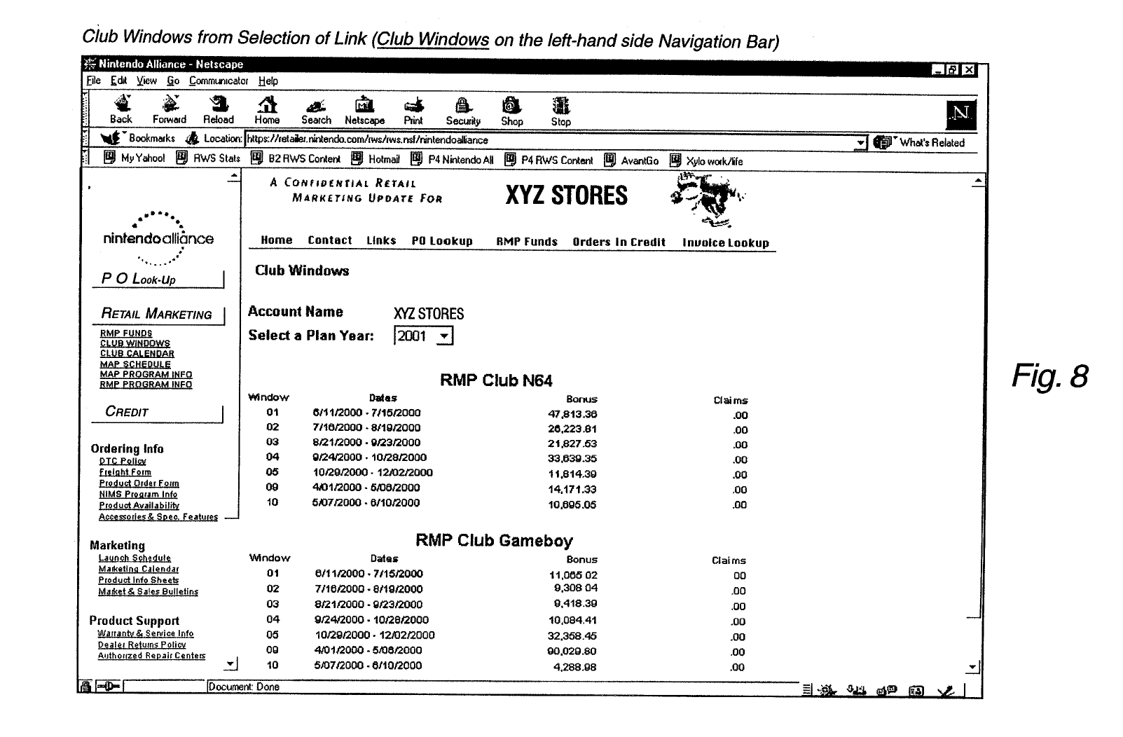

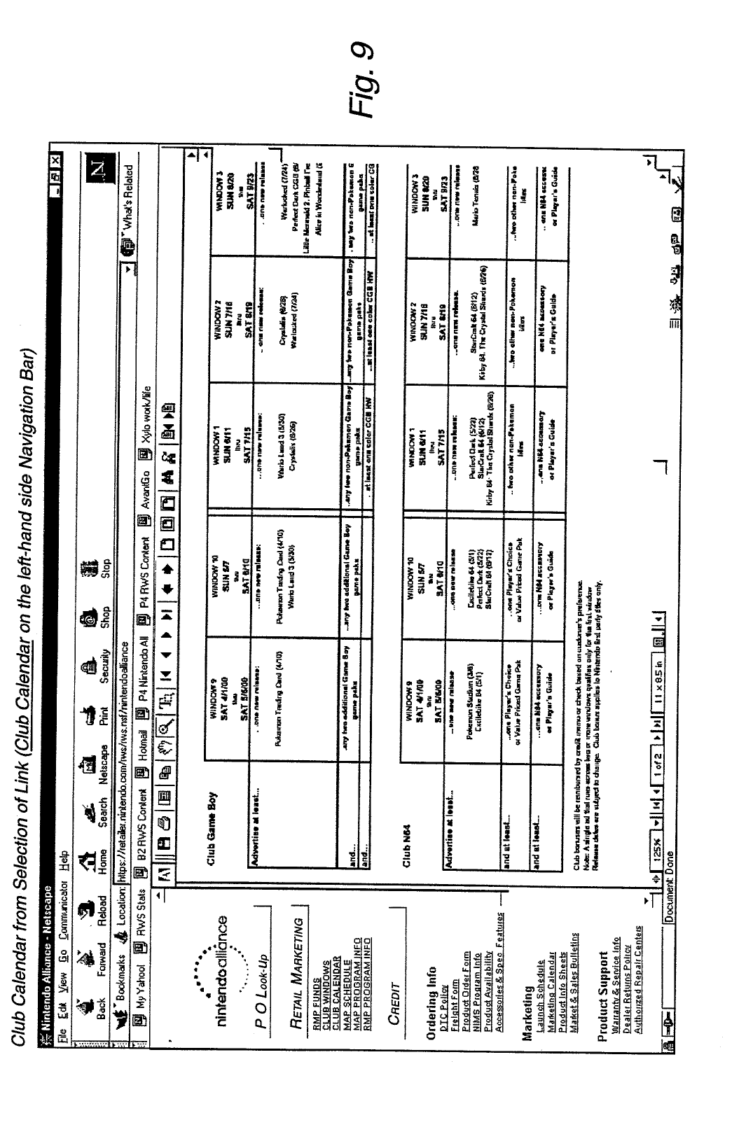

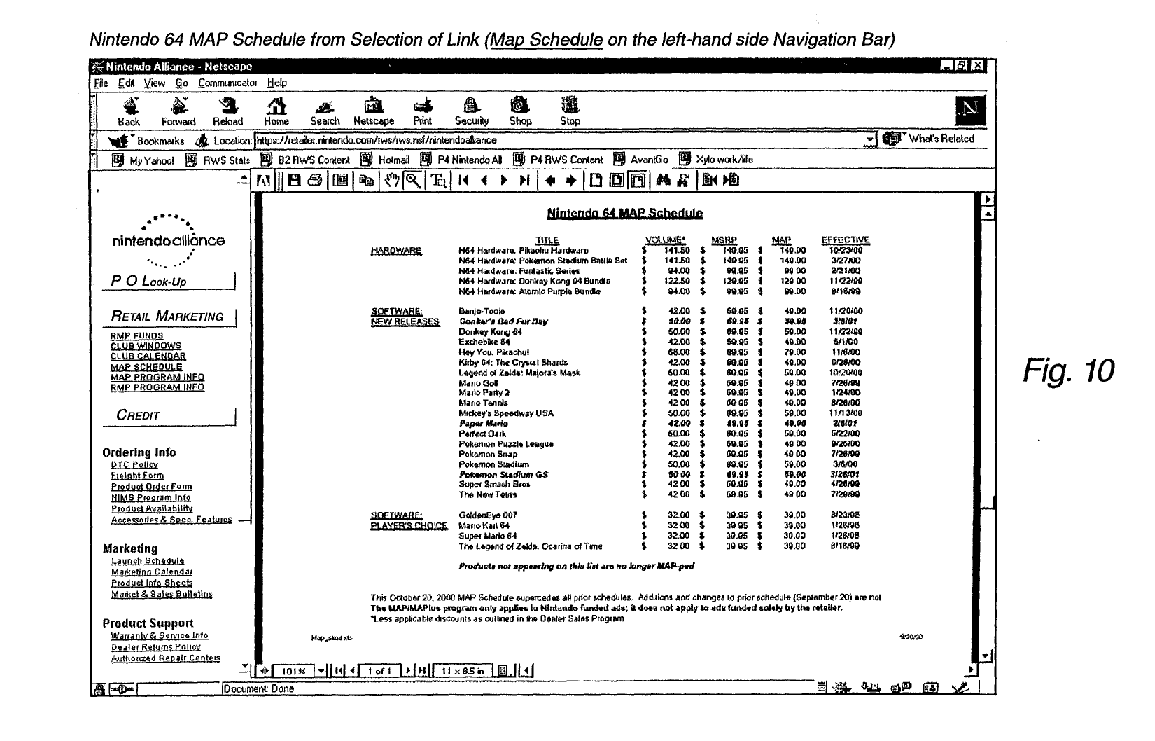

A user will be able to thus review online marketing program data such as the total amounts of money of its net shipments, accruals and accrual rates (see FIGS. 2 and 3), approved expenditures for advertising (see FIGS. 2 and 4), approved expenditures for merchandising (see FIGS. 2 and 5), approved expenditures for promotions (see FIGS. 2 and 6), pending claims (see FIGS. 2 and 7) and balances (see FIG. 2). A user can also review online the amount of bonus monetary credit it has earned for its RMP fund through performing certain tasks such as advertising certain product(s) during a specific time period (see FIG. 8) and/or advertising a product for at least a minimum advertised price (MAP) (see FIG. 10), and how additional bonus credit can be earned (see FIG. 9).

Since the users can access and review their accounts online, the users can obtain up-to-date information (e.g., obtain daily updates) at any time desired without delay. The users can also search for and find specific information related to their respective accounts in an expedient manner through, for example, the links provided on each web page and navigation bar(s). Moreover, more than one representative of the user (e.g., retailer) can access the data as long as he/she has the appropriate URL and log-in password.

The web pages illustrated in FIGS. 2-10 allow the user to review online data relating to its RMP account with the vendor. As will be appreciated by those skilled in the art, the web pages may be accessible as part of a broader web site. For the purpose of explaining the present invention, the user enrolled in the vendor's marketing program is (in this example) XYZ Stores.

FIG. 2 illustrates a web page of the web site which displays a RMP plan statement for the current fiscal year or for a previous fiscal year as selected by the user. The RMP plan statement provides a summary of the amount of money for “Net Shipments” (the amount of money spent by the user, XYZ Stores, in ordering certain products from the vendor), “Accruals” (monetary credit earned by the user, XYZ Stores, to spend on marketing the vendor's products subject to vendor's approval), “Approved Expenditures” (monetary amount of the “Accruals” that has been approved by the vendor for the user to spend in marketing the vendor's products), “RMP Balance” (“Total Accruals” minus “Total claims” of the “Approved Expenditures”), “Pending claims” (monetary amount of expenditure requests submitted by the user, XYZ Stores, to the vendor for approval), and “Pending Balance” (“RMP Balance” minus “Pending claims”).

The RMP plan statement illustrated in the web page of FIG. 2 includes at least five links which the user can select to obtain more detailed information. The five links include: “By Product Line”, “Advertising”, “Merchandising”, “Promotions”, and “Pending claims.” FIGS. 3-7 respectively illustrate the web pages of the web site that are presented to the user as a result of the selection by the user of one of these five links.

FIG. 3 illustrates a web page presented to the user resulting from the selection of the link “By Product Line” on the RMP plan statement illustrated in FIG. 2. The web page illustrated in FIG. 3 provides an accounting of the net shipment by product line. As can be seen from the left-most column in FIG. 3, the product lines for which XYZ Stores earns credit include, for example, “CGB”, “DMG” and “GBD”, etc. and the total monetary amount that XYZ Stores ordered from the vendor for each product line is listed in the middle column labeled “Net Shipments.” Accordingly, detailed line item descriptions of the net shipments for each product line that has earned money for XYZ Stores' RMP fund are displayed. The accrual rate on each type of product line is displayed in the right-most column illustrated in FIG. 3. For example, it can be seen that XYZ Stores earns a 3.00% accrual on net shipments for “CGB” and 2.00% on net shipments for “NUS” for its RMP fund.

FIG. 4 illustrates a web page presented to the user resulting from the selection of the link “Advertising” from the RMP plan statement illustrated in FIG. 2. Specifically, the web page illustrated in FIG. 4 provides, inter alia, a detailed listing of the monetary amounts of the RMP fund that have been approved by the vendor for the user to spend in advertising the vendor's products. Information (from the left-most column to the right-most column) such as the customer reference, advertisement dates, claim type (e.g., magazine, insert, samples), monetary amounts requested by the user, monetary amounts approved by the vendor, monetary amounts rejected by the vendor, monetary amounts pending and any comments are displayed. The respective sum totals of the columns labeled “Amount Requested”, “Amount Approved”, “Amount Rejected” and “Amount Pending” are displayed at the bottom of the web page (not shown in FIG. 4). Accordingly, the current amount of RMP funds that have been approved by the vendor for use by the user in advertising the vendor's products may be instantly accessed and reviewed by the user.

FIG. 5 illustrates a web page presented to the user resulting from the selection of the link “Merchandising” from the RMP plan statement illustrated in FIG. 2. Specifically, the web page illustrated in FIG. 5 provides, inter alia, a detailed listing of the monetary amounts that have been approved by the vendor for the user, XYZ Stores, to use in merchandising the vendor's products. Information (from the leftmost column to the right-most column) such as the customer reference, claim dates, claim types (e.g., display), monetary amounts requested by the user, monetary amounts approved by the vendor, monetary amounts rejected by the vendor, monetary amounts pending and any comments is displayed for each claim by the user. The respective sum totals of the columns labeled “Amount Requested”, “Amount Approved”, “Amount Rejected” and “Amount Pending” are displayed at the bottom of the web page. Accordingly, the current amount of RMP funds that have been approved by the vendor for use by the user in merchandising the vendor's products may be instantly accessed and reviewed by the user.

FIG. 6 illustrates a web page presented to the user resulting from the selection of the link “Promotions” from the RMP plan statement illustrated in FIG. 2. Specifically, the web page illustrated in FIG. 6 provides, inter alia, a detailed listing of the monetary amounts that have been approved by the vendor for the user, XYZ Stores, to use in promotions of the vendor's products. Information (from the left-most column to the right-most column) such as the customer reference, ad dates, claim types, monetary amounts requested by the user, monetary amounts approved by the vendor, monetary amounts rejected by the vendor, monetary amounts pending and any comments is displayed for each claim by the user. The respective sum totals of the columns labeled “Amount Requested”, “Amount Approved”, “Amount Rejected” and “Amount Pending” are displayed at the bottom of the web page. Accordingly, the current amount of RMP funds that have been approved by the vendor for use by the user in promotions of the vendor's products may be instantly accessed and reviewed by the user.

FIG. 7 illustrates a web page presented to the user resulting from the selection of the link “Pending claims” from the RMP plan statement illustrated in FIG. 2. The web page illustrated in FIG. 7 provides details on all types of expenditure requests from claims submitted by the user, XYZ Stores, to the vendor. Specifically, detailed descriptions of each of the user's open claims are displayed. Information (from the left-most column of the right-most column) such as the customer reference, ad dates, claim types, monetary amounts requested by the user, monetary amounts approved by the vendor, monetary amounts rejected by the vendor, monetary amounts pending and any comments is displayed. The respective sum totals of the columns labeled “Amount Requested”, “Amount Approved”, “Amount Rejected” and “Amount Pending” are listed at the bottom of the web page (not shown). Accordingly, the current amount of RMP funds that have been not yet been approved by the vendor for use by the user in marketing the vendor's products may be instantly accessed and reviewed by the user.

A navigation bar provided on the left-hand side of each of the web pages (see, e.g., FIGS. 2-7) of the web site includes the following links: “Club Windows”, “Club Calendar” and “Map Schedule.”

FIG. 8 illustrates a web page presented to the user resulting from the selection of the link “Club Windows” from the left-hand side navigation bar. The web page of FIG. 8 illustrates the current statement of the Club Windows bonus program. The Club Windows bonus program defines specific time periods of opportunity, outlined by the vendor, when the retailer can accrue pre-defined bonus amounts of money for the RMP fund if it performs certain tasks. For example, as can be seen in the web page illustrated in FIG. 9, a user can earn bonus money for its RMP fund if it advertises Pokemon® trading cards and any two additional Game Boy® game packs during the time window of Saturday, April 1 to Saturday, May 6. The web page illustrated in FIG. 8 lists the range of qualifying dates of the bonus program, the retailer's monetary bonus amounts and any current claims for each product line. The window dates and requirements can be displayed upon selection of the “Club Calendar” link on the left-hand side navigation bar.

FIG. 9 illustrates a web page presented to the user resulting from the selection of the link “Club Calendar” from the left-hand side navigation bar. The requirements for a user to qualify for bonus money for its RMP fund appear in each of the numbered windows of the Club Calendar. That is, detailed descriptions of the requirements for each window in the Club Calendar are listed, while column headings separate each window by date. As discussed above for example, a user can earn bonus money for its RMP fund if it advertises Pokemon trading cards and any two additional Game Boy game packs during the time window of Saturday, April 1 to Saturday, May 6 (see window #9 of “Club Game Boy®.”)

FIG. 10 illustrates a web page presented to the user resulting from the selection of the link “Map Schedule” from the left-hand side navigation bar. The web page illustrated in FIG. 10 lists, inter alia, the manufacturer's suggested retail price (MSRP) and the minimum advertised price (MAP) for the vendor's products. The MAP represents the lowest price at which a user can advertise a product and accrue bonus money for its RMP fund in the vendor's minimum advertised price program bonus (MAP program bonus). In the MAP program, users can accrue bonus monetary credit satisfying program requirements such as advertising certain products at least at a minimum level determined by the vendor. Bonus monetary credit that a user earns for the RMP fund through the MAP program bonus (see FIG. 10 and “Maplus Bonus Accrual” in FIG. 2) is added to the “Regular (RMP) Accruals” to obtain the “Total Accruals” (see FIG. 2). The bonus credit can accrue, for example, from a percentage of the user's purchase of a particular type of product from the vendor.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of marketing comprising:
determining a cost of at least one item ordered by a user;
calculating an amount of credit for use by the user to defray costs of its marketing activities, the amount of credit being based on a cost of the ordered item;
providing data relating to the amount of credit to a computer system; and
generating a web page using the data provided to the computer system, the web page displaying the amount of credit available to the user for its marketing activities.

2. The method of claim 1 wherein the marketing activities comprise at least one of advertising, merchandising or promotions.

3. The method of claim 1 further comprising establishing an online link on the web page, wherein selection of the online link initiates another web page that displays at least one of the following: a cost of each item ordered by the user, an accrual rate used to determine an amount of credit for each item ordered by the user, an amount of credit already approved for use by the user, and pending request(s) for expenditures from the user.

4. The method of claim 1 further comprising determining bonus credit earned by the user by performing tasks, the bonus credit being used by the user to defray costs of its marketing activities.

5. The method of claim 4 wherein the tasks performed by the user to earn bonus credit comprise advertising a certain item during a predetermined time period.

6. The method of claim 4 wherein the tasks performed by the user to earn bonus credit comprise advertising a certain item for at least a predetermined price.

7. A method of implementing a marketing program for item(s) being sold by a user, the method comprising:
generating an internet web page using a computer system, the web page being accessible by the user;
determining a cost of an item ordered by the user;
calculating an amount of credit based on the cost of the item ordered by the user, the amount of credit being for use by the user to defray costs associated with marketing the item(s) being sold by the user; and
displaying, via the web page, the amount of credit available for use by the user.

8. The method of claim 7 wherein marketing the item(s) being sold by the user comprises at least one of advertising the item(s), merchandising the item(s) and conducting a promotion of the item(s).

9. The method of claim 7 further comprising establishing an online link on the web page, wherein selection of the online link initiates display of another web page that displays at least one of the following: a cost of each item ordered by the user, an accrual rate used to determine an amount of credit for each item ordered by the user, an amount of credit already approved for use by the user, and pending request(s) for expenditures from the user.

10. The method of claim 7 further comprising determining bonus credit earned by the user by performing tasks, the bonus credit being used by the user to defray costs of its marketing activities.

11. The method of claim 10 wherein the tasks performed by the user to earn bonus credit comprise advertising a certain item during a predetermined time period.

12. The method of claim 10 wherein the tasks performed by the user to earn bonus credit comprise advertising a certain item for at least a predetermined price.

13. A method of marketing comprising:
determining a cost of at least one item ordered by a user;
calculating an amount of credit for use by the user to defray costs of its marketing activities, the amount of credit being based on a cost of the ordered item;
determining an amount of bonus credit also for use by the user to defray costs of its marketing activities, the bonus credit being earned by the user if the user has advertised, merchandised or promoted a certain item;
calculating a total amount of credit by adding the amount of credit based on the cost of the ordered item and the bonus credit;
providing data relating to the total amount of credit to a computer system; and
generating a web page using the data provided to the computer system, the web page displaying at least the total amount of credit available to the user for its marketing activities.

14. The method of claim 13 wherein the bonus credit is earned if the user has advertised a certain item during a predetermined period of time.

15. The method of claim 13 wherein the bonus credit is earned if the user has advertised a certain item for at least a predetermined price.

16. A method of implementing a marketing program for items being sold by a user, the method comprising:
generating an internet web page using a computer system, the web page being accessible by the user;
determining a cost of an item ordered by the user;
calculating an amount of first credit based on the cost of the item ordered by the user, the amount of first credit being for use by the user to defray costs associated with marketing the items being sold by the user;
determining an amount of bonus credit also for use by the user to defray costs of its marketing activities, bonus credit being earned if the user has advertised, merchandised or promoted a certain item;
calculating a total amount of credit by adding the first credit and the bonus credit;
displaying, via the web page, at least the total amount of credit available for use by the user to defray costs of its marketing activities.

17. The method of claim 16 wherein the bonus credit is earned if the user has advertised, merchandised or promoted a certain item during a predetermined period of time.

18. The method of claim 13 wherein the bonus credit is earned if the user has advertised a certain item for at least a predetermined price.

19. A method of marketing comprising:
determining an amount of credit to be awarded to a user to defray costs of its marketing activities
determining whether the user is entitled to the credit by determining whether the user has advertised, merchandised or promoted a certain item;
providing data relating to the amount of credit awarded to the user to a computer system; and
generating a web page using the data provided to the computer system, the web page displaying at least the amount of credit available to the user to defray the costs of its marketing activities.

20. The method of claim 19 wherein the credit is awarded to the user if the user has advertised, merchandised or promoted a certain item during a predetermined period of time.

21. The method of claim 19 wherein the credit is awarded to the user if the user has advertised a certain item for at least a predetermined price.

22. A method of implementing a marketing program for items being sold by a user, the method comprising:
generating an internet web page using a computer system, the web page being accessible by the user;
determining an amount of credit to be awarded to a user to defray costs of its marketing activities;
determining whether the user is entitled to the credit by determining whether the user has advertised, merchandised or promoted a certain item;
providing data relating to the amount of credit awarded to the user to a computer system; and
displaying, via the web page, at least the amount of credit available for use by the user to defray costs of its marketing activities.

23. The method of claim 22 wherein the credit is awarded to the user if the user has advertised, merchandised or promoted a certain item during a predetermined period of time.

24. The method of claim 22 wherein the credit is awarded to the user if the user has advertised a certain item for at least a predetermined price.
